(19) United States
(12) Patent Application Publication
(10) Pub. No.: US 2026/0081628 A1
(43) Pub. Date: Mar. 19, 2026

(54) COMMUNICATION SYSTEM

(71) Applicants: Kabushiki Kaisha Toshiba, Tokyo (JP); Toshiba Electronic Devices & Storage Corporation, Tokyo (JP)

(72) Inventors: Takaaki SHIMIZU, Shinagawa Tokyo (JP); Shinichi FUKASE, Fukaya Saitama (JP)

(21) Appl. No.: 19/070,197

(22) Filed: Mar. 4, 2025

(30) Foreign Application Priority Data
Sep. 18, 2024 (JP) 2024-161227

(51) Int. Cl. H04B 1/04

(52) U.S. Cl. CPC H04B 1/04

(57) ABSTRACT

A communication system includes: a first insulated transmission circuit including a first transmitter, an insulated transmitter, and a first receiver; and a second insulated transmission circuit including a second transmitter, an insulated transmitter, and a second receiver. The first transmitter converts a first input signal to a first transmission signal. The insulated transmitter performs insulated transmission of the first transmission signal from a primary chip to a secondary chip. The first receiver demodulates the first transmission signal. The second transmitter converts a second input signal to a second transmission signal. The insulated transmitter performs insulated transmission of the second transmission signal from the secondary chip to the primary chip. The second receiver demodulates the second transmission signal. A control logic circuit detects reception of the first transmission signal and transmits a transmission start signal. The second transmitter transmits the second transmission signal on the basis of the transmission start signal.

### CROSS-REFERENCE TO RELATED APPLICATION

This application is based upon and claims the benefit of priority from Japanese Patent Application No. 2024-161227, filed Sep. 18, 2024; the entire contents of which are incorporated herein by reference.

### FIELD

An embodiment of the present invention relates to a communication system.

### BACKGROUND

A communication system that performs bidirectional insulated transmission between a primary chip and a secondary chip is known. In such a communication system, when insulated transmission from the primary chip to the secondary chip and insulated transmission from the secondary chip to the primary chip overlap, an erroneous operation may be caused due to interference between switching noise.

### BRIEF DESCRIPTION OF THE DRAWINGS

FIG. 1 is a block diagram showing an example of a configuration of a communication system according to an embodiment.

FIG. 2 is a waveform diagram showing an example of operations of the communication system according to the embodiment.

FIG. 3 is a diagram schematically showing examples of a first pulse and a second pulse which can be employed by the communication system 1 according to the embodiment.

FIG. 4 is a block diagram showing an example of a configuration of a communication system according to a modified example.

### DETAILED DESCRIPTION

A communication system according to an embodiment is a communication system that performs insulated transmission between a primary chip and a secondary chip. The communication system includes a first insulated transmission circuit, a second insulated transmission circuit, and a control logic circuit. The first insulated transmission circuit performs insulated transmission of a first input signal from the primary chip to the secondary chip. The second insulated transmission circuit performs insulated transmission of a second input signal from the secondary chip to the primary chip. The control logic circuit connects the first insulated transmission circuit and the second insulated transmission circuit in the secondary chip. The first insulated transmission circuit includes a first transmitter, an insulated transmitter, and a first receiver. The first transmitter receives the first input signal in the primary chip and converts the received first input signal to a first transmission signal. The insulated transmitter performs insulated transmission of the first transmission signal from the primary chip to the secondary chip. The first receiver receives and demodulates the first transmission signal in the secondary chip and outputs a first output signal. The second insulated transmission circuit includes a second transmitter, an insulated transmitter, and a second receiver. The second transmitter receives the second input signal in the secondary chip and converts the received second input signal to a second transmission signal. The insulated transmitter performs insulated transmission of the second transmission signal from the secondary chip to the primary chip. The second receiver receives and demodulates the second transmission signal in the primary chip and outputs a second output signal. The control logic circuit detects reception of the first transmission signal in the first receiver and transmits a transmission start signal to the second transmitter. The second transmitter transmits the second transmission signal on the basis of the transmission start signal.

Hereinafter, a communication system according to an embodiment will be described with reference to the accompanying drawings.

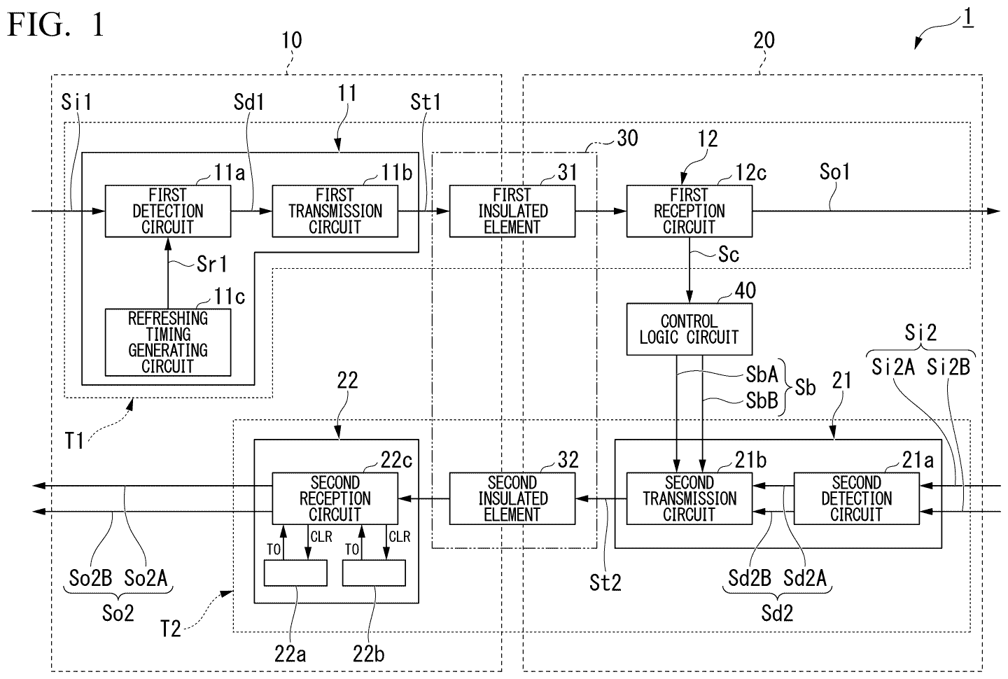

FIG. 1 is a block diagram showing an example of a configuration of a communication system 1 according to an embodiment. The communication system 1 according to the present embodiment is, for example, a digital isolator.

The communication system 1 according to the present embodiment includes a primary chip 10, a secondary chip 20, and an insulated transmitter 30. The communication system 1 performs bidirectional transmission of digital logic signals between the primary chip 10 and the secondary chip 20 which are electrically isolated. That is, the communication system 1 performs insulated transmission between the primary chip 10 and the secondary chip 20.

A first transmitter 11 and a second receiver 22 are mounted in the primary chip 10. A first receiver 12, a second transmitter 21, and a control logic circuit 40 are mounted in the secondary chip 20. The insulated transmitter 30 connects the primary chip 10 and the secondary chip 20. The insulated transmitter 30 includes a first insulated element 31 and a second insulated element 32.

The communication system 1 includes a first insulated transmission circuit T1, a second insulated transmission circuit T2, and the control logic circuit 40. The first insulated transmission circuit T1 is provided over both the primary chip 10 and the secondary chip 20. Similarly, the second insulated transmission circuit T2 is provided over both the primary chip 10 and the secondary chip 20. The control logic circuit 40 is provided in the secondary chip 20.

The first insulated transmission circuit T1 performs insulated transmission of a first input signal Si1 from the primary chip 10 to the secondary chip 20. The first insulated transmission circuit T1 includes the first transmitter 11, the first insulated element 31, and the first receiver 12. The first input signal Si1 is, for example, a gate control signal.

The second insulated transmission circuit T2 performs insulated transmission of a second input signal Si2 from the secondary chip 20 to the primary chip 10. The second insulated transmission circuit T2 includes the second transmitter 21, the second insulated element 32, and the second receiver 22. In the present embodiment, the second insulated transmission circuit T2 performs insulated transmission of a plurality of second input signals Si2. The plurality of second input signals Si2 includes a second input signal Si2A (a second input signal A) and a second input signal Si2B (a second input signal B). The second input signal Si2A and the second input signal Si2B are, for example, a ready signal or a fault signal.

As described above, the first insulated element 31 and the second insulated element 32 are parts of the insulated transmitter 30. Accordingly, the insulated transmitter 30 is shared by the first insulated transmission circuit T1 and the second insulated transmission circuit T2. Each of the first insulated transmission circuit T1 and the second insulated transmission circuit T2 includes the insulated transmitter 30. In the present embodiment, the first insulated element 31 and the second insulated element 32 are insulated transformers, but are not limited thereto.

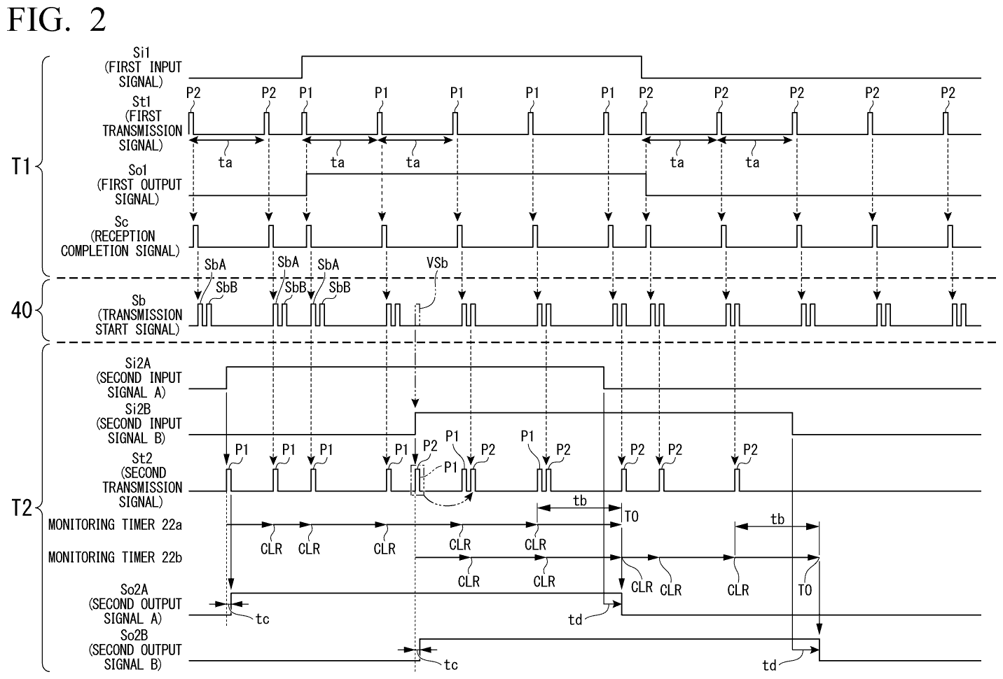

FIG. 2 is a waveform diagram showing examples of operations of the communication system 1. As shown in FIG. 2, the first insulated transmission circuit T1, the second insulated transmission circuit T2, and the control logic circuit 40 in the communication system 1 perform communication using a first pulse P1 and a second pulse P2. Although the first pulse P1 and the second pulse P2 are simplified in FIG. 2, the first pulse P1 and the second pulse P2 are actually more complex pulse waveforms. That is, the first pulse P1 and the second pulse P2 have different signal forms each other.

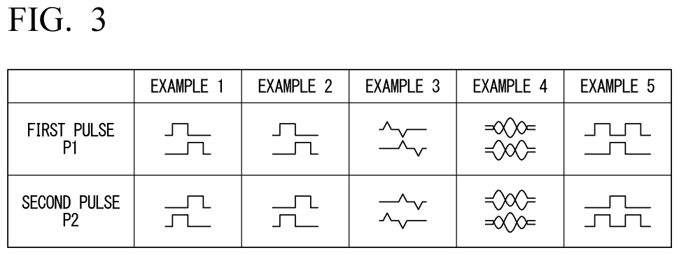

FIG. 3 is a diagram schematically showing examples of a first pulse P1 and a second pulse P2 in the first insulated transmission circuit T1 according to the present embodiment. The waveform of Example 1 is an encoded waveform in the first transmitter 11. The waveform of Example 2 is, for example, a pulse waveform of a first transmission signal St1 which is transmitted by the first transmitter 11. The waveform of Example 3 is, for example, a waveform of the first transmission signal St1 which is output from the first insulated element 31 and which is received by a first reception circuit 12c. The waveform of Example 4 is, for example, a waveform of a received pulse obtained by causing the first reception circuit 12c to shape and amplify the pulse waveform shown in Example 3. The waveform of Example 5 is a waveform of a received pulse obtained by causing the first reception circuit 12c to binarize the received pulse shown in Example 4. Accordingly, for example, the first reception circuit 12c demodulates the waveform of Example 5 and outputs a first output signal So1. In this way, the first pulse P1 and the second pulse P2 used in the first insulated transmission circuit T1 have different signal forms each other. The first pulse P1 and the second pulse P2 used in the first insulated transmission circuit T1 may have pulse waveforms other than the pulse waveforms of the examples shown in FIG. 3 as long as they have different signal forms each other. The pulse waveforms used in the second insulated transmission circuit T2 may be the same pulse waveforms as the pulse waveforms shown in FIG. 3 or pulse waveforms different from these pulse waveforms. That is, the first pulse P1 and the second pulse P2 used in the second insulated transmission circuit T2 may be the same as in the first insulated transmission circuit T1 as long as they have different signal forms each other.

The constituents of the communication system 1 will be described below in detail with reference to FIGS. 1 and 2.

As shown in FIG. 1, the first transmitter 11 includes, for example, a first detection circuit 11a, a first transmission circuit 11b, and a refreshing timing generating circuit 11c. The first transmitter 11 receives the first input signal Si1 in the primary chip 10 and converts the received first input signal Si1 to a first transmission signal St1. The first input signal Si1 changes between a first level and a second level which are different voltage levels each other. In the present embodiment, the first level is a high level, and the second level is a low level which is a voltage level lower than the first level. However, the high level and the low level of the first input signal Si1 may be opposite to those in the present embodiment.

The refreshing timing generating circuit 11c is connected to the first detection circuit 11a. The refreshing timing generating circuit 11c transmits a refreshing timing signal Sr1 to the first detection circuit 11a. The refreshing timing signal Sr1 is transmitted to the first detection circuit 11a, for example, at intervals of a predetermined time (hereinafter referred to as a refreshing period ta).

The first detection circuit 11a is connected to an external control device (not shown), the first transmission circuit 11b, and the refreshing timing generating circuit 11c. For example, the first detection circuit 11a receives the first input signal Si1 from the external control device. The first detection circuit 11a receives the refreshing timing signal Sr1 from the refreshing timing generating circuit 11c. The first detection circuit 11a determines the state of the first input signal Si1, that is, whether the first input signal Si1 is at a high level (a first level) or a low level (a second level).

The first detection circuit 11a transmits a first detection signal Sd1 corresponding to the level of the first input signal Si1 to the first transmission circuit 11b at a timing (a rising timing) at which the first input signal Si1 changes from a low level to a high level and at a timing (that is, a falling timing) at which the first input signal Si1 changes from a high level to a low level. The first detection circuit 11a transmits the first detection signal Sd1 corresponding to the level of the first input signal Si1 to the first transmission circuit 11b at a timing at which the refreshing timing signal Sr1 has been received from the refreshing timing generating circuit 11c. That is, the first detection circuit 11a transmits the first detection signal Sd1 to the first transmission circuit 11b at intervals of the predetermined time (a refreshing period ta).

The first transmission circuit 11b is, for example, an encoder. The first transmission circuit 11b is connected to the first detection circuit 11a and the first insulated element 31. The first transmission circuit 11b generates a first transmission signal St1 in response to the first detection signal Sd1 received from the first detection circuit 11a and transmits the generated first transmission signal St1 to the first insulated element 31. The first transmission circuit 11b generates the first transmission signal St1 corresponding to the level of the first input signal Si1 and transmits the generated first transmission signal St1 to the first insulated element 31.

As shown in FIG. 2, the first transmission signal St1 includes a first pulse P1 and a second pulse P2. The first transmission circuit 11b transmits the first pulse P1 or the second pulse P2 as the first transmission signal St1, for example, in synchronization with rising or falling of the first input signal Si1. The first transmission circuit 11b generates the first pulse P1 when the first input signal Si1 is at a high level and generates the second pulse P2 when the first input signal Si1 is at a low level.

The timings at which the first transmitter 11 generates and transmits the first pulse P1 and the second pulse P2 will be described below with reference to FIG. 2.

The first transmitter 11 generates the first pulse P1 and transmits the generated first pulse P1 to the first insulated element 31 when the first input signal Si1 changes from a low level to a high level (at the rising timing). The first transmitter 11 generates the first pulse P1 at intervals of a predetermined time (the refreshing period ta) and transmits the generated first pulse P1 to the first insulated element 31 when the first input signal Si1 is maintained at a high level.

The first transmitter 11 generates the second pulse P2 and transmits the generated second pulse P2 to the first insulated element 31 when the first input signal Si1 changes from a high level to a low level (at the falling timing). The first transmitter 11 generates the second pulse P2 at intervals of a predetermined time (the refreshing period ta) and transmits the generated second pulse P2 to the first insulated element 31 when the first input signal Si1 is maintained at a low level.

According to the present embodiment, the first transmitter 11 transmits the first pulse P1 or the second pulse P2 in the refreshing period ta and transmits the first pulse P1 or the second pulse P2 regardless of the refreshing period ta when the level changes between a low level and a high level. Accordingly, the first pulse P1 and the second pulse P2 which are the first transmission signal St1 are transmitted at least at intervals equal to or shorter than the refreshing period ta. That is, as long as the communication system 1 is driven, the first transmitter 11 continues to normally transmit the first pulse P1 or the second pulse P2 at intervals equal to or shorter than the refreshing period ta.

As shown in FIG. 1, the first insulated element 31 is disposed over the primary chip 10 and the secondary chip 20. The first insulated element 31 is connected to the first transmission circuit 11b and the first reception circuit 12c. The first insulated element 31 transmits the first transmission signal St1 generated by the first transmitter 11 to the first receiver 12. That is, the first insulated element 31 performs insulated transmission of the first transmission signal St1 from the primary chip 10 to the secondary chip 20.

For example, the first insulated element 31 transmits the first pulse P1 and the second pulse P2 as the first transmission signal St1 from the primary chip 10 to the secondary chip 20 while securing galvanic insulation and outputs the first transmission signal St1 to the first receiver 12.

The first receiver 12 includes, for example, the first reception circuit 12c. The first receiver 12 receives and demodulates the first transmission signal St1 in the secondary chip and generates a first output signal So1. The first receiver 12 outputs the generated first output signal So1 to the outside.

The first reception circuit 12c includes, for example, a decoder, a comparator, and an amplifier. The first reception circuit 12c is connected to the first insulated element 31 and an external device (not shown). The first reception circuit 12c generates the first output signal So1 on the basis of the first pulse P1 and the second pulse P2 as the first transmission signal St1 received from the first insulated element 31.

As shown in FIG. 2, when the first pulse P1 is received, the first reception circuit 12c generates the first output signal So1 of a high level and outputs the first output signal So1 to the outside until a next pulse is received. When the second pulse P2 is received, the first reception circuit 12c generates the first output signal So1 of a low level and outputs the first output signal So1 to the outside until a next pulse is received.

As shown in FIG. 1, the first reception circuit 12c is connected to the control logic circuit 40. The first reception circuit 12c can generate a reception completion signal Sc and transmit the reception completion signal Sc to the control logic circuit 40.

As shown in FIG. 2, the reception completion signal Sc is, for example, a rectangular pulse signal. However, the signal form of the reception completion signal Sc is not limited. The first receiver 12 generates the reception completion signal Sc and transmits the reception completion signal Sc to the control logic circuit 40 whenever the first pulse P1 and the second pulse P2 are received as the first transmission signal St1. The first receiver 12 transmits the reception completion signal Sc of the same signal form regardless of whether the first transmission signal St1 is the first pulse P1 or the second pulse P2.

As shown in FIG. 1, the control logic circuit 40 is connected to the first receiver 12 and the second transmitter 21. That is, the control logic circuit 40 connects the first insulated transmission circuit T1 and the second insulated transmission circuit T2 in the secondary chip 20. The control logic circuit 40 receives the reception completion signal Sc from the first receiver 12. The control logic circuit 40 transmits a transmission start signal Sb to the second transmitter 21. In the present embodiment, the transmission start signal Sb includes a first transmission start signal SbA and a second transmission start signal SbB.

The control logic circuit 40 detects that the first receiver 12 receives the first transmission signal St1 by receiving the reception completion signal Sc from the first receiver 12. When the reception completion signal Sc is received, the control logic circuit 40 generates the transmission start signal Sb and transmits the transmission start signal Sb to the second transmitter 21. That is, the control logic circuit 40 detects that the first receiver 12 receives the first transmission signal St1 and transmits the transmission start signal Sb to the second transmitter 21.

As shown in FIG. 2, the transmission start signal Sb in the present embodiment includes the first transmission start signal SbA and the second transmission start signal SbB. The first transmission start signal SbA and the second transmission start signal SbB are generated at different timings each other. The second transmission start signal SbB is generated with a delay with respect to the first transmission start signal SbA. The control logic circuit 40 continuously transmits the first transmission start signal SbA and the second transmission start signal SbB to the second transmitter 21. As shown in FIG. 1, the first transmission start signal SbA and the second transmission start signal SbB are transmitted to the second transmitter 21 via different signal lines each other.

As shown in FIG. 1, the second transmitter 21 includes, for example, a second detection circuit 21a and a second transmission circuit 21b. The second transmitter 21 receives a second input signal Si2 in the secondary chip 20 and converts the second input signal Si2 to a second transmission signal St2.

The second detection circuit 21a is connected to an external device (not shown) and the second transmission circuit 21b. For example, the second detection circuit 21a receives two second input signals Si2A and Si2B from the external device. The second input signal Si2A changes between a third level and a fourth level which are different voltage levels each other. In the present embodiment, the third level is a high level, and the fourth level is a low level which is a voltage level lower than the third level. However, the high level and the low level of the second input signal Si2A may be opposite to those in the present embodiment. Similarly, the second input signal Si2B changes between a fifth level and a sixth level which are different voltage levels each other. In the present embodiment, the fifth level is a high level, and the sixth level is a low level which is a voltage level lower than the fifth level. However, the high level and the low level of the second input signal Si2B may be opposite to those in the present embodiment. The second detection circuit 21a individually detects states of the second input signals Si2A and Si2B, that is, whether the second input signals Si2A and Si2B are at a high level or a low level.

The second detection circuit 21a is connected to the second transmission circuit 21b. The second detection circuit 21a can transmit two types of second detection signals Sd2 corresponding to the two second input signals Si2A and Si2B. In the following description, when the two types of second detection signals are distinguished, a signal corresponding to the second input signal Si2A is referred to as a second detection signal Sd2A, and a signal corresponding to the second input signal Si2B is referred to as a second detection signal Sd2B.

The second detection circuit 21a transmits the second detection signal Sd2A to the second transmission circuit 21b, for example, at a timing (a rising timing) at which the second input signal Si2A changes from a low level (the fourth level) to a high level (the third level). The second detection circuit 21a transmits the second detection signal Sd2B to the second transmission circuit 21b, for example, at a timing (a rising timing) at which the second input signal Si2B changes from a low level (the sixth level) to a high level (the fifth level).

The second transmission circuit 21b is, for example, an encoder. The second transmission circuit 21b is connected to the control logic circuit 40, the second detection circuit 21a, and the second insulated element 32. The second transmission circuit 21b generates the second transmission signal St2 on the basis of the transmission start signal Sb received from the control logic circuit 40 and the second detection signal Sd2 received from the second detection circuit 21a and transmits the generated second transmission signal St2 to the second insulated element 32.

As shown in FIG. 2, the second transmission signal St2 includes the first pulse P1 and the second pulse P2. The second transmission circuit 21b transmits the first pulse P1 or the second pulse P2 at a timing at which the second detection signal Sd2 is received. That is, the second transmission circuit 21b transmits the first pulse P1 or the second pulse P2 at the timing (rising timing) at which the second input signal Si2A or the second input signal Si2B changes from a low level to a high level. The second transmission circuit 21b transmits the first pulse P1 at the timing at which the first transmission start signal SbA is received and transmits the second pulse P2 at the timing at which the second transmission start signal SbB is received. The second transmission circuit 21b generates the first pulse P1 when the second input signal Si2A is at a high level and generates the second pulse P2 when the second input signal Si2B is at a high level. The second transmission circuit 21b does not transmit the second transmission signal St2 when both the second input signal Si2A and the second input signal Si2B are at a low level.

The timings at which the second transmitter 21 transmits the first pulse P1 and the second pulse P2 will be described below in detail with reference to FIG. 2.

As described above, transmission of the second transmission signal St2 from the second transmitter 21 is performed at timings at which the second input signals Si2A and Si2B rise and at a timing at which the second transmitter 21 receives the transmission start signal Sb.

When the second input signal Si2A changes from a low level to a high level (at the rising timing), the second transmitter 21 generates the first pulse P1 and transmits the first pulse P1 to the second insulated element 32. When the second input signal Si2B changes from a low level to a high level (at the rising timing), the second transmitter 21 generates the second pulse P2 and transmits the second pulse P2 to the second insulated element 32.

When the first transmission start signal SbA is received and the second input signal Si2A is at a high level, the second transmitter 21 generates the first pulse P1 and transmits the first pulse P1 to the second insulated element 32. When the second transmission start signal SbB is received and the second input signal Si2B is at a high level, the second transmitter 21 transmits the second pulse P2.

In the present embodiment, the control logic circuit 40 transmits the transmission start signal Sb to the second transmitter 21 after having received the reception completion signal Sc. Accordingly, transmission of the transmission start signal Sb from the control logic circuit 40 is delayed by at least a pulse width of the reception completion signal Sc with respect to transmission of the first transmission signal St1 from the first transmitter 11. Accordingly, according to the present embodiment, it is possible to deviate transmission of the second transmission signal St2 from transmission of the first transmission signal St1 and to curb simultaneous transmission of the first transmission signal St1 and the second transmission signal St2.

The operation of the second transmitter 21 when the rising timing of the second input signal Si2A and Si2B and the timing at which the second transmitter 21 receives the transmission start signal Sb match will be described below.

For example, as indicated by a virtual line (an alternate long and two short dashes line) in FIG. 2, it is assumed that a virtual transmission start signal VSb is transmitted at the same timing as the rising timing of the second input signal Si2B. Although not shown in FIG. 2, the virtual transmission start signal VSb is transmitted, for example, at the rising timing or the falling timing of the first input signal Si1. That is, a process when the rising or falling timing of the first input signal Si1 and the rising timing of the second input signal Si2B match will be described below. In this case, the second transmission circuit 21b simultaneously receives a pulse of the transmission start signal VSb and a pulse of the second detection signal Sd2B.

When the virtual transmission start signal VSb is not transmitted (that is, as indicated by a solid line in FIG. 2), the second transmission circuit 21b receives only the pulse of the second detection signal Sd2B corresponding to the rising of the second input signal Si2B. In this case, as indicated by the solid line in FIG. 2, the second transmission circuit 21b transmits the second pulse P2.

On the other hand, as indicated by the virtual line in FIG. 2, the second transmission circuit 21b simultaneously receives the pulse of the second detection signal Sd2B indicating the rising of the second input signal Si2B and the pulse of the transmission start signal VSb. In this case, the second transmission circuit 21b originally needs to simultaneously perform a process (transmission of the second pulse P2) in response to reception of the second detection signal Sd2B and a process (transmission of the first pulse P1) in response to reception of the transmission start signal VSb. However, the second transmission circuit 21b cannot simultaneously transmit the first pulse P1 and the second pulse P2. Therefore, the second transmission circuit 21b in the present embodiment gives a priority to the process in response to reception of the transmission start signal VSb and performs transmission of the first pulse P1 (indicated by the virtual line in FIG. 2). The second transmission circuit 21b stops transmission of the second pulse P2 (indicated by the solid line in FIG. 2) which is the process in response to reception of the second detection signal Sd2B. That is, when the process in response to reception of the second detection signal Sd2B and the process in response to reception of the transmission start signal VSb overlap, the second transmission circuit 21b preferentially performs the process in response to reception of the transmission start signal VSb. The stopped process in response to reception of the second detection signal Sd2B is postponed until a next pulse of the transmission start signal Sb is received.

According to the present embodiment, when signals requiring different processes are simultaneously received, the second transmitter 21 can perform the processes while securing reliability. By giving a priority to the process corresponding to the transmission start signal VSb, it is possible to curb the time intervals at which the first pulse P1 (or the second pulse P2) is transmitted becoming equal to or greater than the refreshing period ta. Accordingly, it is possible to secure reliability of demodulation of the second output signal So2 in the second receiver 22 described later.

As shown in FIG. 1, the second insulated element 32 is disposed over the primary chip 10 and the secondary chip 20. The second insulated element 32 is connected to the second transmission circuit 21b and the second reception circuit 22c. The second insulated element 32 transmits the second transmission signal St2 generated by the second transmitter 21 to the second receiver 22. That is, the second insulated element 32 performs insulated transmission of the second transmission signal St2 from the secondary chip 20 and the primary chip 10.

The second insulated element 32 transmits the first pulse P1 and the second pulse P2 as the second transmission signal St2 from the primary chip 10 to the secondary chip 20 while securing galvanic insulation and outputs the second transmission signal St2 to the second receiver 22.

The second receiver 22 includes, for example, the second reception circuit 22c, a first monitoring timer 22a, and a second monitoring timer 22b. The second receiver 22 receives and demodulates the second transmission signal St2 in the secondary chip and generates a second output signal So2. The second receiver 22 outputs the generated second output signal So2 to the outside.

As described above, a plurality of second input signals Si2A and Si2B are input to the second insulated transmission circuit T2 in the present embodiment. Accordingly, the second insulated transmission circuit T2 outputs a plurality of second output signals So2A and So2B corresponding to the second input signals Si2A and Si2B. The plurality of second output signals So2 include a second output signal So2A (a second output signal A) and a second output signal So2B (a second output signal B). The second output signal So2A (the second output signal A) is a signal that is output in response to the second input signal Si2A (the second input signal A). Accordingly, a high level (the third level) of the second input signal Si2A corresponds to a high level (the third level) of the second output signal So2A, a low level (the fourth level) of the second input signal Si2A corresponds to a low level (the fourth level) of the second output signal So2A. The second output signal So2B (the second output signal B) is a signal that is output in response to the second input signal Si2B (the second input signal B). Accordingly, a high level (the fifth level) of the second input signal Si2B corresponds to a high level (the fifth level) of the second output signal So2B, and a low level (the sixth level) of the second input signal Si2B corresponds to a low level (the sixth level) of the second output signal So2B. The second receiver 22 outputs the second output signal So2A on the basis of the first pulse P1. The second receiver 22 outputs the second output signal So2B on the basis of the second pulse P2.

The second reception circuit 22c includes, for example, an amplifier, a converter, and a decoder. The second reception circuit 22c is connected to the first insulated element 31, the first monitoring timer 22a, the second monitoring timer 22b, and an external device (not shown). The second reception circuit 22c receives the first pulse P1 and the second pulse P2 which are the second transmission signal St2 and generates and outputs the second output signal So2 to the external device.

The first monitoring timer 22a and the second monitoring timer 22b are connected to the second reception circuit 22c. The first monitoring timer 22a measures a time which elapses after the second reception circuit 22c has received the first pulse P1. The second monitoring timer 22b measures a time which elapses after the second reception circuit 22c has received the second pulse P2.

Operations of the first monitoring timer 22a, the second monitoring timer 22b, and the second reception circuit 22c will be described below with reference to FIG. 2.

The second reception circuit 22c transmits a reset signal to the first monitoring timer 22a every time the second reception circuit 22c receives the first pulse P1 from the second insulated element 32. The second reception circuit 22c transmits a reset signal to the second monitoring timer 22b every time the second reception circuit 22c receives the second pulse P2 from the second insulated element 32.

The first monitoring timer 22a receives the reset signal transmitted from the second reception circuit 22c and is reset (CLR). When the time which elapses after the first pulse P1 has been received is greater than a predetermined monitoring period tb, the first monitoring timer 22a notifies the second reception circuit 22c of timeout (TO).

The second monitoring timer 22b receives the reset signal transmitted from the second reception circuit 22c and is reset (CLR). When the measured time is greater than the predetermined monitoring period tb, the second monitoring timer 22b notifies the second reception circuit 22c of timeout (TO).

When the first pulse P1 is received, the second reception circuit 22c transmits the reset signal to the first monitoring timer 22a and changes the second output signal So2A from a low level to a high level. When the notification of timeout (TO) is received from the first monitoring timer 22a, the second reception circuit 22c changes the second output signal So2A from a high level to a low level. Accordingly, the second reception circuit 22c can demodulate the second output signal So2A.

When the second pulse P2 is received, the second reception circuit 22c transmits the reset signal to the second monitoring timer 22b and changes the second output signal So2B from a low level to a high level. When the notification of timeout (TO) is received from the second monitoring timer 22b, the second reception circuit 22c changes the second output signal So2B from a high level to a low level. Accordingly, the second reception circuit 22c can demodulate the second output signal So2B.

When the first input signal Si1 is maintained at a high level or a low level, the first transmitter 11 in the present embodiment transmits the first pulse P1 or the second pulse P2 at intervals of a predetermined time (the refreshing period ta). When the level of the first input signal Si1 changes, the first transmitter 11 transmits the first pulse P1 or the second pulse P2 regardless of the refreshing period ta. Accordingly, the first transmitter 11 transmits the first pulse P1 or the second pulse P2 at least at intervals equal to or less than the refreshing period ta. The second transmitter 21 transmits the first pulse P1 or the second pulse P2 with a pulse transmitted from the first transmitter 11 as a trigger. Accordingly, when the second input signal Si2A is maintained at a high level, the second transmitter 21 transmits the first pulse P1 at least at intervals equal to or less than the refreshing period ta. Similarly, when the second input signal Si2B is maintained at a high level, the second transmitter 21 transmits the second pulse P2 at least at intervals equal to or less than the refreshing period ta. In the present embodiment, the monitoring period tb is longer than the refreshing period ta. Accordingly, since the first monitoring timer 22a and the second monitoring timer 22b notify of timeout (TO) on the basis of the monitoring period tb, the second receiver 22 can determine that the second input signals Si2A and Si2B are not maintained at a high level on the basis of the notification of timeout (TO).

In the second insulated transmission circuit T2 according to the present embodiment, the second transmitter 21 transmits the first pulse P1 or the second pulse P2 as the second transmission signal St2 at the rising timing of the second input signal Si2. Accordingly, the second insulated transmission circuit T2 can minimize a delay time tc of the rising of the second output signal So2 with respect to the rising of the second input signal Si2.

In the second insulated transmission circuit T2 according to the present embodiment, the second receiver 22 generates the falling timing of the second output signal So2 in response to the notification of timeout (TO) from the first monitoring timer 22a or the second monitoring timer 22b. Accordingly, the second insulated transmission circuit T2 can set a delay time td of the falling of the second output signal So2 with respect to the falling of the second input signal Si2 to a time equal to or shorter than the monitoring period tb.

Operations and advantages of the present embodiment will be described below.

The communication system 1 according to the embodiment is a communication system 1 that performs insulated transmission between the primary chip 10 and the secondary chip 20. The communication system 1 includes the first insulated transmission circuit T1, the second insulated transmission circuit T2, and the control logic circuit 40. The first insulated transmission circuit T1 performs insulated transmission of a first input signal Si1 from the primary chip 10 to the secondary chip 20. The second insulated transmission circuit T2 performs insulated transmission of a second input signal Si2 from the secondary chip 20 to the primary chip 10. The control logic circuit 40 connects the first insulated transmission circuit T1 and the second insulated transmission circuit T2 in the secondary chip 20. The first insulated transmission circuit T1 includes the first transmitter 11, the insulated transmitter 30, and the first receiver 12. The first transmitter 11 receives the first input signal Si1 in the primary chip 10 and converts the received first input signal Si1 to a first transmission signal St1. The insulated transmitter 30 performs insulated transmission of the first transmission signal St1 from the primary chip 10 to the secondary chip 20. The first receiver 12 receives and demodulates the first transmission signal St1 in the secondary chip 20 and outputs a first output signal So1. The second insulated transmission circuit T2 includes the second transmitter 21, the insulated transmitter 30, and the second receiver 22. The second transmitter 21 receives the second input signal Si2 in the secondary chip 20 and converts the received second input signal Si2 to a second transmission signal St2. The insulated transmitter 30 performs insulated transmission of the second transmission signal St2 from the secondary chip 20 to the primary chip 10. The second receiver 22 receives and demodulates the second transmission signal St2 in the primary chip 10 and outputs a second output signal So2. The control logic circuit 40 detects reception of the first transmission signal St1 in the first receiver 12 and transmits a transmission start signal Sb to the second transmitter 21. The second transmitter 21 transmits the second transmission signal St2 on the basis of the transmission start signal Sb.

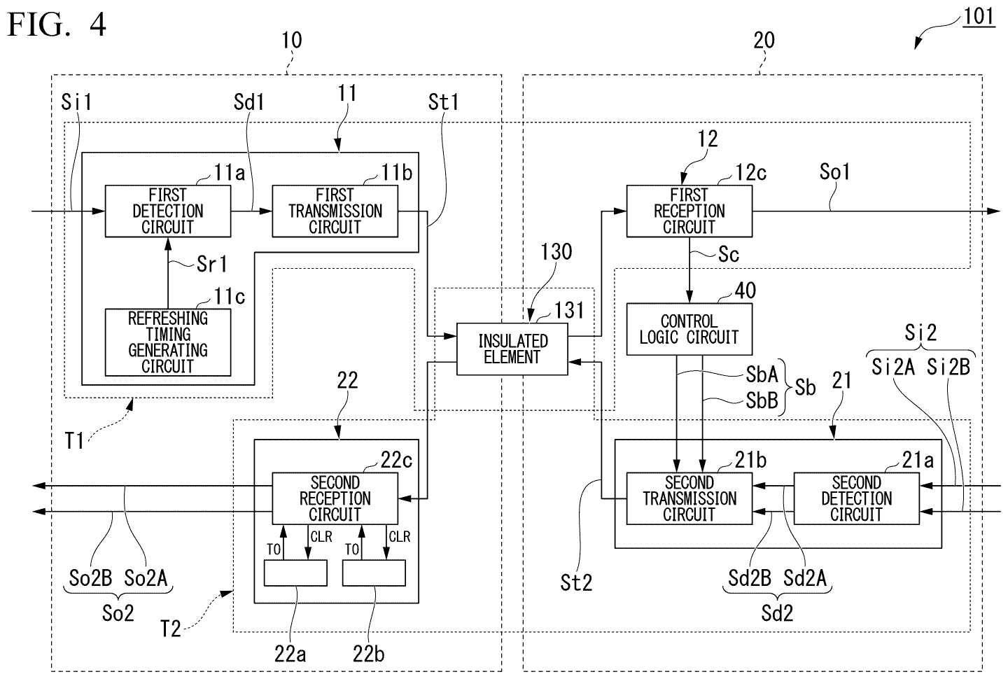

With this configuration, the second transmitter 21 performs transmission of the second transmission signal St2 on the basis of the transmission start signal Sb. The transmission start signal Sb is transmitted after the first transmission signal St1 has been received by the first receiver 12. Accordingly, a timing at which insulated transmission of the first transmission signal St1 is performed in the first insulated transmission circuit T1 and a timing at which insulated transmission of the second transmission signal St2 is performed in the second insulated transmission circuit T2 can be deviated from each other. As a result, it is possible to prevent noise due to the first transmission signal St1 and the second transmission signal St2 from affecting each other to cause an erroneous operation. It is possible to prevent electromagnetic interference (EMI) due to the first transmission signal St1 and the second transmission signal St2 from overlapping to affect an external device. With the communication system 1, since the transmission timings of the first transmission signal St1 and the second transmission signal St2 are deviated from each other, a configuration in which insulated transmission of the first input signal Si1 and the second input signal Si2 is performed using one insulated element 131 can be employed as described in Modified Example 1 (see FIG. 4) which will be described later.

In the communication system 1, the first transmission signal St1 includes the first pulse P1 and the second pulse P2 which have different signal forms each other. When the first input signal Si1 changes from a low level to a high level and when the first input signal Si1 is maintained at the high level, the first transmitter 11 transmits the first pulse P1 at intervals of a predetermined time. When the first input signal Si1 changes from the high level to the low level and when the first input signal Si1 is maintained at the low level, the first transmitter 11 transmits the second pulse P2 at intervals of a predetermined time.

With this configuration, the first transmission signal St1 includes the first pulse P1 which is assigned when the first input signal Si1 is at a high level and the second pulse P2 which is assigned when the first input signal Si1 is at a low level. Accordingly, it is possible to minimize a delay with respect to the rising and the falling of the first input signal Si1 and to convert the first input signal Si1 to the first transmission signal St1. That is, with this configuration, in the communication system 1 that performs bidirectional insulated transmission, it is possible to curb at least a delay of insulated transmission of the first input signal Si1 in the first insulated transmission circuit T1.

In the communication system 1, the second input signal Si2 includes a second input signal Si2A and a second input signal Si2B. The second transmission signal St2 includes the first pulse P1 and the second pulse P2 which are different signal forms each other. When the transmission start signal Sb is received and the second input signal Si2A is at a high level, the second transmitter 21 transmits the first pulse P1. When the transmission start signal Sb is received and the second input signal Si2B is at a high level, the second transmitter 21 transmits the second pulse P2.

With this configuration, when the second input signal Si2 includes two signals (the second input signals Si2A and Si2B), the two second input signals Si2A and Si2B can be converted to the second transmission signal St2 including the first pulse P1 and the second pulse P2. Accordingly, it is not necessary to increase the number of insulated transmission circuits according to the number of signals included in the second input signal Si2 in the communication system 1 and it is possible to achieve a decrease in size of the communication system 1.

In the aforementioned communication system 1, the transmission start signal Sb includes a first transmission start signal SbA and a second transmission start signal SbB. The second transmission start signal SbB is generated with a delay with respect to the first transmission start signal SbA. The second transmitter 21 transmits the first pulse P1 when the first transmission start signal SbA is received and the second input signal Si2A is at a high level. The second transmitter 21 transmits the second pulse P2 when the second transmission start signal SbB is received and the second input signal Si2B is at a high level.

With this configuration, the control logic circuit 40 transmits the first transmission start signal SbA corresponding to the second input signal Si2A and the second transmission start signal SbB corresponding to the second input signal Si2B at different timings. The second transmitter 21 transmits the first pulse P1 with reception of the first transmission start signal SbA as a trigger and transmits the second pulse P2 with reception of the second transmission start signal SbB as a trigger. Accordingly, the second transmitter 21 can transmit the first pulse P1 and the second pulse P2 at different timings without overlapping the pulses.

In the communication system 1, the second transmitter 21 transmits the first pulse P1 when the second input signal Si2A changes from a low level to a high level. The second transmitter 21 transmits the second pulse P2 when the second input signal Si2B changes from a low level to a high level.

With this configuration, the second transmitter 21 transmits the first pulse P1 or the second pulse P2 when the rising of the second input signal Si2A or the second input signal Si2B is detected in addition to when the transmission start signal Sb is received. Accordingly, it is possible to minimize a delay with respect to the rising of the second input signal Si2A and the second input signal Si2B and to convert the second input signal Si2 to the second transmission signal St2. That is, with this configuration, it is possible to curb a delay of insulated transmission of the second input signal Si2 in the second insulated transmission circuit T2. When this configuration is employed, the second transmitter 21 transmits the second transmission signal St2 at the timing at which the rising of the second input signal Si2 is detected regardless of reception of the transmission start signal Sb. Accordingly, when this configuration is employed, the timing at which the first transmission signal St1 is transmitted and the timing at which the second transmission signal St2 is transmitted may overlap with a low probability. As a result, this configuration can be preferably employed when the rising frequency of the second input signal Si2A and the second input signal Si2B is low and overlap of the timings is sufficiently rare. On the other hand, instead of employing this configuration, a configuration in which the second transmission signal St2 is transmitted only when the second transmitter 21 receives the transmission start signal Sb may be employed. In this case, it is possible to fully deviate the timing at which the first transmission signal St1 is transmitted and the timing at which the second transmission signal St2 is transmitted from each other and to construct the communication system 1 with higher reliability.

The second transmitter 21 includes the second detection circuit 21a and the second transmission circuit 21b. The second detection circuit 21a transmits the second detection signal Sd2 when the level of the second input signal Si2 changes. The second transmission circuit 21b transmits the second transmission signal St2 to the insulated transmitter 30 on the basis of the second detection signal Sd2 and the transmission start signal Sb. The second transmission circuit 21b preferentially performs the process in response to reception of the transmission start signal VSb when the process in response to reception of the second detection signal Sd2 and the process in response to reception of the transmission start signal VSb which is virtually shown in FIG. 2 overlap.

With this configuration, when different processes are required to be simultaneously performed, the second transmitter 21 can secure reliability by giving a priority to a predetermined one. As indicated by the virtual line (the alternate long and two short dashes line) in FIG. 2, by giving a priority to transmission of the second transmission signals St2 with respect to reception of the transmission start signal VSb, it is possible to curb time intervals at which the first pulse P1 or the second pulse P2 is transmitted becoming too long. Accordingly, it is possible to demodulate the second transmission signal St2 to the second output signal So2 using the time intervals of the first pulse P1 or the second pulse P2 of the first transmission signal St1.

In the communication system 1, the second receiver 22 outputs the second output signal So2A as the second output signal So2 on the basis of the first pulse P1. The second receiver 22 outputs the second output signal So2B as the second output signal So2 on the basis of the second pulse P2.

With this configuration, it is possible to demodulate the second output signal So2A and the second output signal So2B on the basis of the first pulse P1 and the second pulse P2. With this configuration, the second insulated transmission circuit T2 can insulated-transmit two second input signals Si2A and Si2B as the second output signals So2A and So2B without requiring a complex configuration.

In the communication system 1, the second receiver 22 includes the second reception circuit 22c, the first monitoring timer 22a, and the second monitoring timer 22b. The second reception circuit 22c receives the first pulse P1 and the second pulse P2 and generates the second output signal So2. The first monitoring timer 22a measures a time which elapses after the second reception circuit 22c has received the first pulse P1. The second monitoring timer 22b measures a time which elapses after the second reception circuit 22c has received the second pulse P2. The second reception circuit 22c changes the second output signal So2A from a low level to a high level when the first pulse P1 is received. The second reception circuit 22c changes the second output signal So2A from a high level to a low level when the time measured by the first monitoring timer 22a is greater than the monitoring period tb. The second reception circuit 22c changes the second output signal So2B from a low level to a high level when the second pulse P2 is received. The second reception circuit 22c changes the second output signal So2B from a high level to a low level when the time measured by the second monitoring timer 22b is greater than the monitoring period tb.

With this configuration, two second input signals Si2A and Si2B converted to the first pulse P1 and the second pulse P2 can be smoothly demodulated to the second output signals So2A and So2B. With this configuration, the falling of the second output signals So2A and So2B is determined using the first monitoring timer 22a and the second monitoring timer 22b. Accordingly, it is possible to accurately demodulate the second output signals So2A and So2B without using a particular configuration as the second receiver 22.

In the communication system 1, the first transmitter 11 transmits a pulse at intervals of a predetermined time (the refreshing period ta) when the first input signal Si1 is maintained at a high level or a low level. The monitoring period tb is longer than the intervals of the predetermined time (the refreshing period ta).

With this configuration, the first transmitter 11 transmits a pulse every refreshing period ta. Accordingly, the period of the transmission start signal Sb is equal to or less than at least the refreshing period ta. As a result, the intervals of the first pulse P1 and the intervals of the second pulse P2 received by the second receiver 22 when the second input signals Si2A and Si2B are maintained at a high level are equal to or less than the refreshing period ta. The second receiver 22 can determine the falling of the second input signal Si2A and the second input signal Si2B on the basis of the monitoring period tb longer than the refreshing period ta. In the aforementioned embodiment, when the rising or falling of the first input signal Si1 is detected, the first transmitter 11 transmits the transmission start signal Sb regardless of the refreshing period ta. Accordingly, the intervals at which the first transmitter 11 transmits the transmission start signal Sb may be shorter than the refreshing period ta.

In the communication system 1, the insulated transmitter 30 includes the first insulated element 31 and the second insulated element 32. The first insulated element 31 performs insulated transmission of the first transmission signal St1 from the primary chip 10 to the secondary chip 20. The second insulated element 32 performs insulated transmission of the second transmission signal St2 from the secondary chip 20 to the primary chip 10.

In the present embodiment, when the first input signal Si1, the second input signals Si2A and Si2B, the first output signal So1, and the second output signals So2A and So2B change between two voltage levels (a high level and a low level), the high level and the low level may be reversed. The high levels and the low levels of the first input signal Si1, the second input signals Si2A and Si2B, the first output signal So1, and the second output signals So2A and So2B may not correspond to each other.

FIG. 4 is a block diagram showing an example of a configuration of a communication system 101 according to a modified example of the aforementioned embodiment. The communication system 101 according to the present modified example is different from that of the aforementioned embodiment mainly in the configuration of the insulated transmitter 130. The same constituents as in the aforementioned embodiment will be referred to by the same reference signs, and descriptions thereof will be omitted.

The insulated transmitter 130 according to the present modified example includes a single insulated element 131. The insulated element 131 serves as a part of the first insulated transmission circuit T1 and also serves as a part of the second insulated transmission circuit T2. The insulated element 131 performs insulated transmission of the first transmission signal St1 from the primary chip 10 to the secondary chip 20 and performs insulated transmission of the second transmission signal St2 from the secondary chip 20 to the primary chip 10.

The communication system 101 according to the present modified example operates in the same way as in the aforementioned communication system 1. That is, the second transmitter 21 transmits the second transmission signal St2 at a timing deviated from the reception timing of the first transmission signal St1 in the first receiver 12. Accordingly, with the insulated transmitter 130 according to the present modified example, it is possible to avoid simultaneous transmission of the first transmission signal St1 and the second transmission signal St2. Accordingly, it is possible to transmit the first transmission signal St1 and the second transmission signal St2 using the single insulated element 131. According to the present modified example, since the communication system 101 includes one insulated element 131, it is possible to achieve a decrease in size of the communication system 101.

According to at least one aforementioned embodiment, since the communication system 1 and 101 include the control logic circuit 40 that detects reception of the first transmission signal St1 and transmits the transmission start signal serving as a trigger for starting transmission of the second transmission signal St2, it is possible to curb overlapping of the transmission timings of the first transmission signal St1 and the second transmission signal St2 and to enhance the reliability of the communication system 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system that performs insulated transmission between a primary chip and a secondary chip, the communication system comprising:
a first insulated transmission circuit configured to perform insulated transmission of a first input signal from the primary chip to the secondary chip;
a second insulated transmission circuit configured to perform insulated transmission of a second input signal from the secondary chip to the primary chip; and
a control logic circuit configured to connect the first insulated transmission circuit and the second insulated transmission circuit in the secondary chip,
wherein the first insulated transmission circuit includes
a first transmitter configured to receive the first input signal in the primary chip and convert the received first input signal to a first transmission signal,
an insulated transmitter configured to perform insulated transmission of the first transmission signal from the primary chip to the secondary chip, and
a first receiver configured to receive and demodulate the first transmission signal in the secondary chip and output a first output signal,
wherein the second insulated transmission circuit includes
a second transmitter configured to receive the second input signal in the secondary chip and convert the received second input signal to a second transmission signal,
the insulated transmitter configured to perform insulated transmission of the second transmission signal from the secondary chip to the primary chip, and
a second receiver configured to receive and demodulate the second transmission signal in the primary chip and output a second output signal,
wherein the control logic circuit is configured to detect reception of the first transmission signal in the first receiver and transmit a transmission start signal to the second transmitter, and
wherein the second transmitter is configured to transmit the second transmission signal on the basis of the transmission start signal.

2. The communication system according to claim 1, wherein the first transmission signal includes a first pulse and a second pulse which have different signal forms each other,
wherein the first input signal changes between a first level and a second level which are different voltage levels each other,
wherein the first transmitter is configured to:
transmit the first pulse at intervals of a predetermined time when the first input signal changes from the second level to the first level and when the first input signal is maintained at the first level; and
transmit the second pulse at intervals of a predetermined time when the first input signal changes from the first level to the second level and when the first input signal is maintained at the second level.

3. The communication system according to claim 1, wherein the second input signal includes a second input signal A and a second input signal B,
wherein the second input signal A changes between a third level and a fourth level which are different voltage levels each other,
wherein the second input signal B changes between a fifth level and a sixth level which are different voltage levels each other,
wherein the second transmission signal includes a first pulse and a second pulse which have different signal forms each other,
wherein the second transmitter is configured to:
transmit the first pulse when the second input signal A is at the third level at the time of receiving of the transmission start signal; and
transmit the second pulse when the second input signal B is at the fifth level at the time of receiving of the transmission start signal.

4. The communication system according to claim 3, wherein the transmission start signal includes a first transmission start signal and a second transmission start signal that is generated with a delay with respect to the first transmission start signal,
wherein the second transmitter is configured to:
transmit the first pulse when the second input signal A is at the third level at the time of receiving of the first transmission start signal; and
transmit the second pulse when the second input signal B is at the fifth level at the time of receiving of the second transmission start signal.

5. The communication system according to claim 3, wherein the second transmitter is configured to:
transmit the first pulse when the second input signal A changes from the fourth level to the third level; and
transmit the second pulse when the second input signal B changes from the sixth level to the fifth level.

6. The communication system according to claim 5, wherein the second transmitter includes
a detection circuit configured to transmit a detection signal when a level of the second input signal changes, and
a transmission circuit configured to transmit the second transmission signal to the insulated transmitter on the basis of the detection signal and the transmission start signal,
wherein the transmission circuit is configured to preferentially perform a process in response to reception of the transmission start signal when a process in response to reception of the detection signal and the process in response to reception of the transmission start signal overlap.

7. The communication system according to claim 3, wherein the second receiver is configured to:
output a second output signal A as the second output signal on the basis of the first pulse; and
output a second output signal B as the second output signal on the basis of the second pulse.

8. The communication system according to claim 7, wherein the second receiver includes
a reception circuit configured to receive the first pulse and the second pulse and generate the second output signal,
a first monitoring timer configured to measure a time which elapses after the reception circuit has received the first pulse, and
a second monitoring timer configured to measure a time which elapses after the reception circuit has received the second pulse,
wherein the reception circuit is configured to:
change the second output signal A from the fourth level to the third level when the first pulse is received;
change the second output signal A from the third level to the fourth level when the time measured by the first monitoring timer is greater than a monitoring period;
change the second output signal B from the sixth level to the fifth level when the second pulse is received; and
change the second output signal B from the fifth level to the sixth level when the time measured by the second monitoring timer is greater than the monitoring period.

9. The communication system according to claim 8, wherein the first transmitter is configured to transmit a pulse at intervals of a predetermined time when the first input signal is maintained at the first level or the second level, and
wherein the monitoring period is longer than the intervals of the predetermined time.

10. The communication system according to claim 1, wherein the insulated transmitter includes:
a first insulated element configured to perform insulated transmission of the first transmission signal from the primary chip to the secondary chip; and
a second insulated element configured to perform insulated transmission of the second transmission signal from the secondary chip to the primary chip.

11. The communication system according to claim 1, wherein the insulated transmitter includes one insulated element, and
wherein the insulated element is configured to:
perform insulated transmission of the first transmission signal from the primary chip to the secondary chip; and
perform insulated transmission of the second transmission signal from the secondary chip to the primary chip.
